(19) United States
(12) Patent Application Publication
(10) Pub. No.: US 2026/0163179 A1
(43) Pub. Date: Jun. 11, 2026

(54) SEPARATOR FOR RECHARGEABLE BATTERY AND RECHARGEABLE BATTERY INCLUDING THE SAME

(71) Applicant: SAMSUNG SDI CO., LTD., Yongin-si (KR)

(72) Inventors: Seung Yeop BAEK, Suwon-si (KR); Kee Wook KIM, Suwon-si (KR)

(73) Assignee: SAMSUNG SDI CO., LTD., Yongin-si (KR)

(21) Appl. No.: 19/414,964

(22) Filed: Dec. 10, 2025

(30) Foreign Application Priority Data
Dec. 11, 2024 (KR) 10-2024-0183832

(51) Int. Cl. H01M 50/42; H01M 50/417; H01M 50/434; H01M 50/443; H01M 50/446; H01M 50/449; H01M 50/491

(52) U.S. Cl. CPC H01M 50/42; H01M 50/417; H01M 50/434; H01M 50/443; H01M 50/446; H01M 50/449; H01M 50/491

(57) ABSTRACT

The present disclosure relates to a separator for a rechargeable battery, and a rechargeable battery including the separator. The separator for a rechargeable battery includes a porous substrate, and a coating layer formed on at least one surface of the porous substrate. The coating layer includes a polymer of a mixture including a filler having an unsaturated group.

### CROSS-REFERENCE TO RELATED APPLICATION

The present application claims priority to Korean Patent Application No. 10-2024-0183832, filed on Dec. 11, 2024, in the Korean Intellectual Property Office, the entire disclosure of which is incorporated herein by reference.

### BACKGROUND

### 1. Field of the Disclosure

The present disclosure relates to a separator for a rechargeable battery, and a rechargeable battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery typically includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

The rechargeable lithium battery may include a separator between the positive electrode and the negative electrode. The separator is impregnated in an electrolyte. It may be advantageous for the separator to maintain an original form thereof without undergoing thermal shrinkage in the electrolyte to secure the safety of the battery.

### SUMMARY

One example embodiment includes a separator for a rechargeable battery in which a dry thermal shrinkage rate and a thermal shrinkage rate in an electrolyte are low, and air permeability is improved.

Another example embodiment includes a separator for a rechargeable battery that decreases resistance of a battery.

Still another example embodiment includes a separator for a rechargeable battery in which heat resistance is improved.

Yet another example embodiment includes a rechargeable battery including the separator for a rechargeable battery.

One example embodiment includes a separator for a rechargeable battery.

The separator for a rechargeable battery includes a porous substrate, and a coating layer formed on at least one surface of the porous substrate, wherein the coating layer includes a polymer of a mixture including a filler having an unsaturated group.

Another example embodiment provides a rechargeable battery including the separator for a rechargeable battery, a positive electrode, and a negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view of a separator for a rechargeable lithium battery according to one example embodiment;

FIG. 2 is a cross-sectional view of a separator for a rechargeable lithium battery according to another example embodiment; and

FIG. 3 to FIG. 6 are cross-sectional views schematically showing rechargeable lithium batteries according to example embodiments.

### DETAILED DESCRIPTION

Hereinafter, example embodiments of the present disclosure are described in detail. However, the example embodiments are presented as examples, and the present disclosure is not limited to the example embodiments, and the present disclosure is only defined by the scope of the appended claims.

Unless otherwise stated herein, when a part such as a layer, a membrane, an area, a plate, and the like, is described as being disposed “on” another part, it includes not only a case where the part is “directly above” another part, but also a case where there is at least one other part therebetween.

Unless otherwise stated herein, the singular expression may also include the plural. In addition, unless otherwise stated, “A or B” may mean “including A, including B, or including A and B.”

In the present specification, “a combination thereof” may mean a mixture, stack, composite, copolymer, alloy, blend, and reaction product of constituents.

In the present specification, “particle diameter D100” refers to a particle diameter of a particle with a cumulative volume of 100% by volume in a particle size distribution. The particle size distribution may be measured by methods known to those skilled in the art. For example, the particle size distribution may be measured using a particle size analyzer or measured using, e.g., a transmission electron micrograph or a scanning electron micrograph. As another method, the particle size distribution may be measured using, e.g., a measuring device using dynamic light scattering, and a D100 value may be obtained by performing data analysis, counting the number of particles in each particle size range, and then calculating the D100 value therefrom. Alternatively, the particle size distribution may be measured using, e.g., a laser diffraction method. When measuring the average particle diameter by a laser diffraction method, for example, D100 based on 100% of a particle diameter distribution in a measuring device may be calculated by dispersing particles to be measured in a dispersion medium, then introducing the particles into a commercially available laser diffraction particle diameter measuring device (e.g., Microtrac's MT 3000), and radiating ultrasonic waves of about 28 kHz at an output power of 60 W.

In the present specification, “particle diameter D50” refers to a particle diameter indicating a diameter of a particle which cumulative volume is 50% by volume in the particle size distribution. The particle diameter distribution may be obtained by referring to the method described for the “particle diameter D100.”

In the present specification, the term “(meth)acryl” refers to acryl and/or methacryl.

Hereinafter, unless otherwise defined, “substitution” means that hydrogen in a compound is substituted with a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br, or I), a hydroxy group (—OH), a nitro group (—NO₂), a cyano group (—CN), an amino group (—NRR′) (here, R and R′ are each independently hydrogen or a C1 to C6 alkyl group), a sulfobetaine group (—RR′N⁺(CH₂)ₙSO₃⁻, n is a natural number from 1 to 10), a carboxybetaine group (—RR′N⁺(CH₂)ₙCOO⁻, n is a natural number from 1 to 10) (here, R and R′ are each independently a C1 to C20 alkyl group), an azido group (—N₃), an amidino group (—C(═NH)NH₂), a hydrazino group (—NHNH₂), a hydrazono group (═N(NH₂)), a carbamoyl group (—C(═O)NH₂), a thiol group (—SH), an acyl group (—C(═O)R, here, R denotes hydrogen, a C1 to C6 alkyl group, a C1 to C6 alkoxy group, or a C6 to C12 aryl group), a carboxyl group (—COOH) or a salt thereof (—C(═O)OM, here, M denotes an organic or inorganic cation), a sulfonic acid group (—SO₃H) or a salt thereof (—SO₃M, here, M denotes an organic or inorganic cation), a phosphate group (—PO₃H₂) or a salt thereof (—PO₃MH or —PO₃M₂, here, M denotes an organic or inorganic cation), and a combination thereof.

Hereinafter, the C1 to C3 alkyl group may be or include at least one of a methyl group, an ethyl group, or a propyl group. The C1 to C10 alkylene group may be or include, for example, at least one of a C1 to C6 alkylene group, a C1 to C5 alkylene group, or a C1 to C3 alkylene group, and may be or include, for example, at least one of a methylene group, an ethylene group, or a propylene group. The C3 to C20 cycloalkylene group may be or include, for example, at least one of a C3 to C10 cycloalkylene group, or a C5 to C10 alkylene group, for example, a cyclohexylene group. The C6 to C20 arylene group may be or include, for example, a C6 to C10 arylene group, for example, a phenylene group. The C3 to C20 heterocyclic group may be or include, for example, a C3 to C10 heterocyclic group, for example, a pyridine group.

Hereinafter, “hetero” means including one or more heteroatoms such as or including at least one of N, O, S, Si, and P.

In addition, in Chemical Formula, the symbol * refers to a part that is connected to the same or different atom, group, or structural unit.

Hereinafter, “alkali metal” refers to an element belonging to Group 1 of the periodic table, such as lithium, sodium, potassium, rubidium, cesium, or francium and may be present in a cationic or neutral state. Additionally, unless specifically mentioned in the chemical formula, it can be assumed that hydrogen is bonded.

In the present specification, upon describing a numerical range, “X to Y” means “X or more and Y or less (X≤ and ≤Y).”

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, the separator for a rechargeable battery of the present disclosure has high heat resistance due to having a low dry thermal shrinkage rate and a low thermal shrinkage rate in an electrolyte, and exhibits improved air permeability. The separator for a rechargeable battery of the present disclosure has a desired or improved effect of reducing resistance of a battery. The separator for a rechargeable battery of the present disclosure can improve the capacity, lifespan, and safety of a battery.

For example, a separator for a rechargeable battery of the related art is formed by coating a composition for a coating layer including a filler and a polymer on at least one surface of a porous substrate, and drying the composition. Therefore, since there is only a physical bond between the filler and the porous substrate, there is a limitation in lowering the thermal shrinkage rate of the separator. On the other hand, in the separator of examples of the present disclosure, since the filler particles are connected to each other by chemical bonds and hold a coating layer more strongly, a thermal shrinkage rate of the separator can be significantly lowered, and the content of a binder used in the related art can be lowered, thereby improving air permeability and lowering the resistance of a battery.

The separator for a rechargeable battery includes a porous substrate, and a coating layer formed on at least one surface of the porous substrate, wherein the coating layer includes a polymer of a mixture including a filler having an unsaturated group.

The porous substrate included in the separator may significantly shrink in an elongation direction when exposed to heat, thereby increasing the thermal shrinkage rate of the separator. In a separator having a porous substrate and a coating layer formed on one surface of the porous substrate and having a filler merely dispersed therein without being bonded, while the filler adjacent to the porous substrate is trapped on the porous substrate, the filler distant from the porous substrate is not trapped on the porous substrate and breaks or strips, and thus a thermal shrinkage rate may be high.

The polymer of the mixture including the filler having an unsaturated group may chemically bond the filler particles to each other, may connect the filler particles to each other as a whole, and may allow the filler particles to be included in the coating layer. Therefore, when the separator is exposed to heat, the positions of the filler particles are stably maintained regardless of the positions of the filler particles from the porous substrate, thereby increasing the heat resistance of the separator compared to a separator including the coating layer having the filler merely dispersed therein, and in this way, a dry thermal shrinkage rate and a thermal shrinkage rate in an electrolyte of the separator can be significantly decreased.

According to one example embodiment, the separator may have a dry thermal shrinkage rate of about 1.5% or less, and a thermal shrinkage rate in an electrolyte of about 2% or less in each of a machine direction (MD) and a transverse direction (TD) of the porous substrate.

In the polymer of the mixture including the filler having an unsaturated group, the filler is integrated into the polymer, and there may be no need to include a separate binder, for example, an adhesive binder, in the coating layer, and accordingly, an effect of improving the air permeability of the separator may be provided, and the resistance of a battery may be reduced.

According to one example embodiment, the separator may have an air permeability of about 120 sec/100 cc or lower.

According to one example embodiment, the separator may have a resistance of about 0.6Ω or lower.

According to one example embodiment, the separator may not include an adhesive binder in the coating layer. Here, the “adhesive binder” is a general binder known to provide adhesiveness to a separator and may include, for example, one or more of a (meth)acrylic adhesive binder including polymethyl methacrylate or the like, and a fluorine-based adhesive binder including polyvinylidene fluoride (PVdF).

The separator according to one example embodiment is described in more detail below.

### Coating Layer

The coating layer includes a polymer of a mixture including a filler having an unsaturated group.

In one example embodiment, the polymer of the mixture including the filler having an unsaturated group may be included in an amount of about 95 wt % or more, for example, in a range of about 95 wt % to about 100 wt %, or 100 wt %, of the coating layer.

The unsaturated group may include a functional group that may be polymerized by light and/or heat. The functional group that may be polymerized by light and/or heat may improve the manufacturing processability of the coating layer and the separator by allowing the polymer to be formed from the mixture by the polymerization caused by light and/or heat. The functional group may be or include one or more of a vinyl group and a (meth)acrylate group.

According to one example embodiment, the unsaturated group may be connected to the filler by a silicon-containing divalent linking group. The silicon-containing divalent linking group may be located between the unsaturated group and the filler to further increase the flexibility of the polymer, thereby increasing impact resistance of the separator against external impacts. The silicon-containing divalent linking group may also hinder or prevent the filler distant from the porous substrate from being readily detached from the porous substrate, or from moving when the separator is exposed to heat, thereby further improving the heat resistance of the separator.

In one example embodiment, the silicon-containing divalent linking group may be or include a C1 to C10 alkylene group having a siloxane group, for example, a C1 to C5 alkylene group having a siloxane group, for example, a C1 to C3 alkylene group having a siloxane group.

In one example embodiment, the filler having an unsaturated group may be or include a filler surface-modified with a silane compound having one or more of a vinyl group and a (meth)acrylate group. The silane compound having one or more of a vinyl group and a (meth)acrylate group may facilitate the introduction of the silicon-containing divalent linking group to the filler and the introduction of the unsaturated group to the filler.

The silane compound having one or more of a vinyl group and a (meth)acrylate group may be represented by Chemical Formula 1 below:

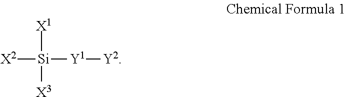

In Chemical Formula 1 above,
X¹, X², and X³ each independently is or includes hydrogen, halogen, a hydroxyl group, a substituted or unsubstituted C1 to C20 alkyl group, a substituted or unsubstituted C6 to C20 aryl group, a substituted or unsubstituted C3 to C20 cycloalkyl group, a substituted or unsubstituted C7 to C20 arylalkyl group, a substituted or unsubstituted C1 to C20 alkoxy group, or a substituted or unsubstituted C6 to C20 aryloxy group,
at least any one of X¹, X², and X³ is or includes a hydroxyl group, halogen, a substituted or unsubstituted C1 to C20 alkoxy group, or a substituted or unsubstituted C6 to C20 aryloxy group,
Y¹ is or includes a divalent C1 to C20 aliphatic hydrocarbon group, a divalent C5 to C20 alicyclic hydrocarbon group, or a divalent C6 to C20 aromatic hydrocarbon group, and
Y² is or includes a vinyl group or a (meth)acrylate group).

In one example embodiment, in Chemical Formula 1 above, Y¹ may be or include a divalent C1 to C20 aliphatic hydrocarbon group, for example, a C1 to C10 alkylene group, or a C1 to C5 alkylene group.

For example, the compound of Chemical Formula 1 above may include at least one or more of 3-(meth)acryloyloxypropyl trialkoxysilane including 3-(meth)acryloyloxypropyl trimethoxysilane, 3-(meth)acryloyloxypropyl triethoxysilane, and the like, 3-(meth)acryloyloxypropyl haloalkylsilane including 3-(meth)acryloyloxypropyl dimethylchlorosilane and the like, 3-(meth)acryloyloxypropyl trihydroxysilane, and vinyltrialkoxysilane including vinyltrimethoxysilane, vinyltriethoxysilane, and the like.

The filler having an unsaturated group may be or include a filler surface-modified with one or more silane compounds having one or more of a vinyl group and a (meth)acrylate group. The surface-modified filler may further improve strength by the silane compounds having one or more of a vinyl group and a (meth)acrylate group being hydrolyzed and condensed.

The preparation of a filler surface-modified with the silane compounds having one or more of a vinyl group and a (meth)acrylate group may be performed by referring to a method known to those skilled in the art. For example, the surface-modified filler may be prepared by mixing a filler with an unmodified surface with a silane compound having one or more of a vinyl group and a (meth)acrylate group, and then allowing a condensation reaction to occur. Among the silane compounds having one or more of a vinyl group and a (meth)acrylate group, an alkoxysilane compound may be modified to a trihydroxysilane compound before modifying the surface of the filler.

The filler may be or include an inorganic filler, an organic filler, an organic/inorganic filler, or a combination thereof.

The inorganic filler may be or include a ceramic material capable of improving heat resistance. The inorganic filler may be or include, for example, at least one of a metal oxide, a semi-metal oxide, a metal fluoride, a metal hydroxide, or a combination thereof. The inorganic filler may be or include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic filler may include at least one of an acrylic compound, an imide compound, an amide compound, or a combination thereof, but is not limited thereto. The organic filler may have a core-shell structure, but is not limited thereto.

In one example embodiment, the filler may be or include a filler having a hydroxyl group on a surface thereof. For the filler having a hydroxyl group on a surface thereof, it may be possible to perform surface modification using the silane compounds having one or more of a vinyl group and a (meth)acrylate group.

For example, the filler may be or include one or more of boehmite, silica, alumina, and zirconia. For example, the filler may be or include boehmite.

The filler may be spherical, sheet-shaped, cubic, or amorphous. For example, the filler may be or include a spherical filler or a sheet-shaped filler.

The filler may have a particle diameter D100 of about 700 nm or less, for example, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700 nm, in a range of about 50 nm to about 700 nm. Within the above range, there may be an effect of reducing shrinkage in an electrolyte.

The filler may have a particle diameter D50 of about 300 nm or less, for example, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300 nm, a range of about 10 nm to about 300 nm. Within the above range, there may be an effect of reducing the shrinkage in an electrolyte.

The filler may be included in an amount in a range of about 50 wt % to about 99 wt %, for example, 70 wt % to 99 wt %, for example, 75 wt % to 99 wt %, for example, 80 wt % to 99 wt %, for example, 85 wt % to 99 wt %, for example, 90 wt % to 99 wt %, for example, 95 wt % to 99 wt %, based on the total amount of the coating layer. When the filler is included within the above range, desired or improved heat resistance, durability, oxidation resistance, and stability may be exhibited.

The mixture may only include the filler having an unsaturated group. However, the mixture may further include a monomer having an unsaturated group.

By being included in the mixture, the monomer having an unsaturated group may hinder or prevent the filler from being included in an excessive amount in the coating layer and reduce or prevent a challenge in which adhesiveness of the coating layer decreases.

According to one example embodiment, the monomer having an unsaturated group may include one or more olefin-based monomers. The olefin-based monomers are monomers in which one or more olefin bonds are present in a monomer and may include, for example, one or more of ethylene, propylene, butadiene, and (meth)acrylic monomers. The (meth)acrylic monomer may be or include one or more of (meth)acrylic acid esters having a C1 to C5 alkyl group in a main chain portion of an ester, for example, one or more of methyl (meth)acrylates.

According to one example embodiment, in the mixture, the filler having an unsaturated group and the monomer having an unsaturated group may be included in a molar ratio in a range of about 1:6 to about 1:20. Within the above range, a precipitation reaction may not occur in the mixture, and cracks or the like may not form in the coating layer even after polymerization. For example, the molar ratio may be 1:6, 1:7, 1:8, 1:9, 1:10, 1:11, 1:12, 1:13, 1:14, 1:15, 1:16, 1:17, 1:18, 1:19, 1:20, in a range of about 1:8 to about 1:12, for example, about 1:10.

According to one example embodiment, the polymer may be represented by any one of Chemical Formulas 2 and 3 below:

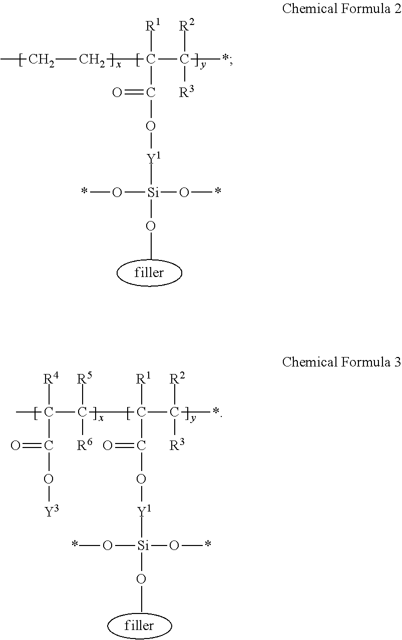

In Chemical Formulas 2 and 3 above,
* is a connecting portion of an element,
R¹, R², R³, R⁴, R⁵, and R⁶ each independently is or includes hydrogen or a methyl group,
Y¹ is or includes a divalent C1 to C20 aliphatic hydrocarbon group, a divalent C5 to C20 alicyclic hydrocarbon group, or a divalent C6 to C20 aromatic hydrocarbon group,
Y³ is or includes a C1 to C5 alkyl group, and
x and y are molar ratios of each unit, 0<x<1, 0<y<1, x+y=1.

In the coating layer, the polymer may be or include a particle type or a film type depending on the content and type of the filler having an unsaturated group, and the monomer having an unsaturated group that are included in the mixture.

The coating layer may be prepared by preparing a polymer of a mixture including the filler having an unsaturated group, preparing a composition for a coating layer including the polymer, applying the composition for a coating layer on at least one surface of the porous substrate, and drying the composition.

The polymer of the mixture including the filler having an unsaturated group may be prepared by polymerizing the mixture using a general method. For example, the polymer may be prepared by adding the filler having an unsaturated group and a polymerization initiator, selectively adding the monomer having an unsaturated group, and mixing and polymerizing the filler and monomer. The polymerization initiator may form radicals by light irradiation, and may include a general photopolymerization initiator such as azobisisobutyronitrile. The content of the photopolymerization initiator may be adjusted according to the content of the filler and/or the monomer in the mixture.

The composition for a coating layer may further include a general additive known to those skilled in the art, in addition to the polymer.

The coating layer may have a thickness in a range of about 1 μm to about 40 μm, for example, a thickness of 1 μm to 30 μm, 1 μm to 20 μm, or 2 μm to 15 μm.

### Porous Substrate

The porous substrate may have a plurality of pores, and may generally be a substrate used in an electrochemical device. Non-limiting examples of the porous substrate may be or include a polymer film formed of or including a polymer, or a copolymer or a mixture of two or more of polyolefin such as polyethylene, polypropylene, and the like, a polyester such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, polyphenylene oxide, a cyclic olefin copolymer, polyphenylene sulfide, polyethylene naphthalate, a glass fiber, Teflon, and polytetrafluoroethylene.

The porous substrate may be or include, for example, a polyolefin-based substrate including polyolefin, and the polyolefin-based substrate may contribute to improving safety of a battery due to the desired or improved shut-down function thereof. The polyolefin-based substrate may be or include, for example, at least one of a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin or a copolymer of olefin and a non-olefin monomer.

The porous substrate may have a thickness in a range of about 1 μm to about 40 μm, for example 1 μm to 30 μm, 1 μm to 20 μm, or 5 μm to 15 μm.

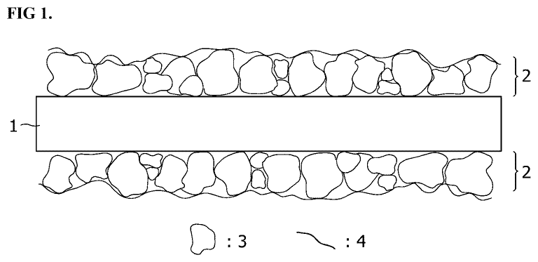

FIG. 1 is a cross-sectional view showing a separator for a rechargeable lithium battery according to one example embodiment.

Referring to FIG. 1, the separator for a rechargeable lithium battery includes a porous substrate 1 and a coating layer 2 located on both surfaces of the porous substrate 1. The coating layer 2 may include a polymer 4 of a filler 3 having an unsaturated group.

According to one example embodiment, the polymer 4 may be independently distributed relative to the porous substrate 1. Here, “independently distributed” means that the polymer 4 and the porous substrate 1 are not connected to each other by any bond or the like.

According to another example embodiment, at least a portion of the polymer 4 may be additionally polymerized to the porous substrate 1. In this way, since the coating layer 2 and the porous substrate 1 are connected to each other, a thermal shrinkage rate of the separator can be significantly lowered.

In one example embodiment, the porous substrate 1 may be modified to have an unsaturated group. The unsaturated group of the porous substrate 1 may be polymerized together when the mixture is polymerized, and in this way, at least a portion of the polymer 4 may be additionally polymerized to the porous substrate 1. The unsaturated group may be or include one or more of a vinyl group and a (meth)acrylate group.

A method for introducing an unsaturated group to the porous substrate 1 is not particularly limited, but a surface of the porous substrate 1 may be modified to prepare a porous substrate 1 having a hydroxyl group, and the porous substrate 1 having a hydroxyl group may be allowed to react with epoxy group-containing (meth)acrylate to prepare a porous substrate 1 having a (meth)acrylate group. For example, the epoxy group-containing (meth)acrylate may be (meth)acrylate having a glycidoxy group.

The porous substrate 1 having a hydroxyl group may be prepared by treating the porous substrate 1 with oxygen plasma. For example, this process may be performed by a method of exposing the porous substrate 1 to RF plasma (13.56 MHz, 500 mTorr, 50 W). In one example embodiment, the porous substrate 1 may be or include a film including one or more resins of polyethylene, polypropylene, and polymethyl methacrylate.

When reacting the porous substrate 1 having a hydroxyl group with the epoxy group-containing (meth)acrylate to prepare a porous substrate 1 having a (meth)acrylate group, a method of slowly adding glycidyl methacrylate to a dimethyl sulfoxide solution having 4-dimethylaminopyridine and 4-methoxyphenol dissolved therein and slowly stirring for 48 hours may be performed.

According to one example embodiment, the coating layer 2 may be prepared by preparing a porous substrate 1 having an unsaturated group, preparing a mixture including a filler 3 having an unsaturated group, preparing the composition for a coating layer including the mixture, applying the composition for a coating layer on at least one surface of the porous substrate 1, and polymerizing the mixture on the porous substrate 1.

The composition for a coating layer may include the filler 3 having an unsaturated group and a polymerization initiator and may selectively include a monomer having an unsaturated group.

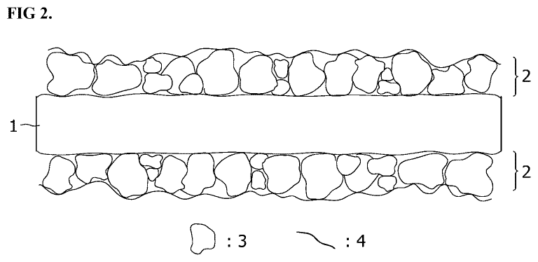

FIG. 2 is a cross-sectional view of a separator for a rechargeable lithium battery according to another example embodiment.

Referring to FIG. 2, a separator for a rechargeable lithium battery includes a porous substrate 1 and a coating layer 2 located on both surfaces of the porous substrate 1. The coating layer 2 may include a polymer 4 of a filler 3 having an unsaturated group. Although not shown in FIG. 2, the porous substrate 1 and the polymer 4 are connected to each other.

### Rechargeable Lithium Battery

According to an example embodiment, the rechargeable lithium battery includes the separator for a rechargeable lithium battery, a positive electrode, and a negative electrode.

The separator for rechargeable lithium battery refers to the description described above. The separator for rechargeable lithium battery may be located between the positive electrode and the negative electrode.

### Positive Electrode

A positive electrode for a rechargeable lithium battery may include a current collector and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free lithium nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≥0.5, 0≤c≤0.5, and 0≤α≤2); LiₐNi_{1-b-c}Mn_{b}X_{c}O_{2-α}D_{α} (0.90≤a≤1.8, 0≤b≥0.5, 0≤c≤0.5, and 0≤α≤2); LiₐNi_{b}Co_{c}L¹_{d}GₑO₂ (0.90≤a≤1.8, 0≤b≥0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof, and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may independently be in a range of about 0.5 wt % to about 5 wt %, respectively, based on 100 wt % of the positive electrode active material layer.

The binder is configured to attach the positive electrode active material particles to each other, and also to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be configured to impart conductivity (e.g., electrical conductivity) to the electrode. Any material that does not cause chemical change (e.g., that does not cause an undesirable chemical change in the rechargeable lithium battery), and that conducts electrons, can be included in the battery. Examples of the conductive material may include a carbon-based material such as or including at least one of natural graphite, artificial graphite, carbon black, acetylene black, ketjen black, a carbon fiber, a carbon nanofiber, and carbon nanotube; a metal-based material containing copper, nickel, aluminum, silver, and the like, in a form of a metal powder or a metal fiber; a conductive polymer such as or including a polyphenylene derivative; or a mixture thereof.

A1 may be included as the current collector, but the current collector is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, at least one of crystalline carbon, amorphous carbon or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be combined with a carbon-based negative electrode active material.

The binder may be configured to attach the negative electrode active material particles to each other, and to attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be configured to impart conductivity (e.g., electrical conductivity) to the electrode. Any material that does not cause chemical change (e.g., that does not cause an undesirable chemical change in the rechargeable lithium battery), and that conducts electrons, can be included in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent is configured to supply lithium ions in a battery, to enable an operation of a rechargeable lithium battery, and to improve transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

The rechargeable lithium battery may be classified into cylindrical, prismatic, pouch, or coin-type batteries, and the like depending on their shape.

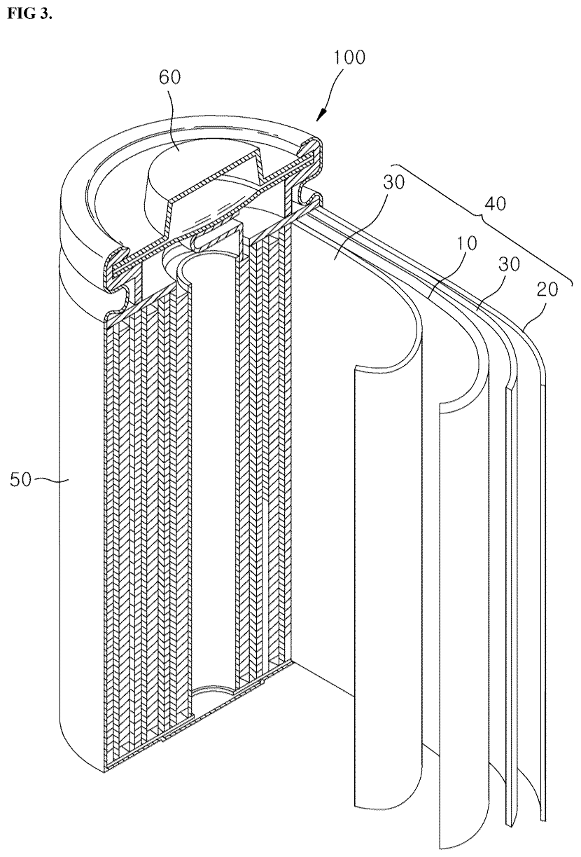

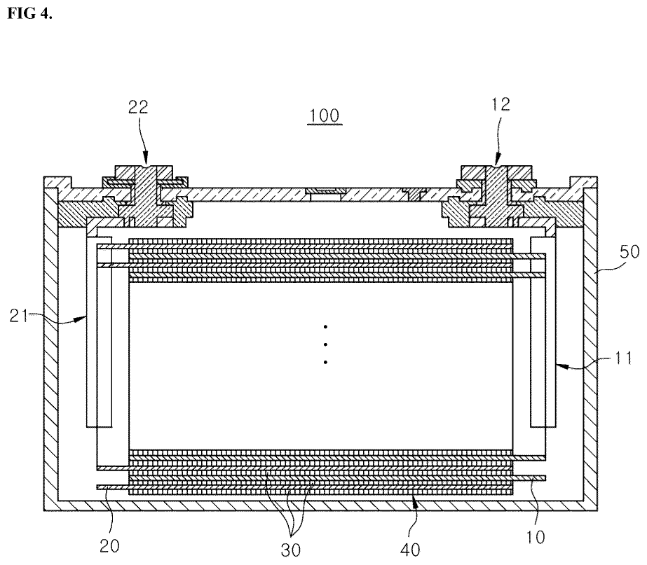

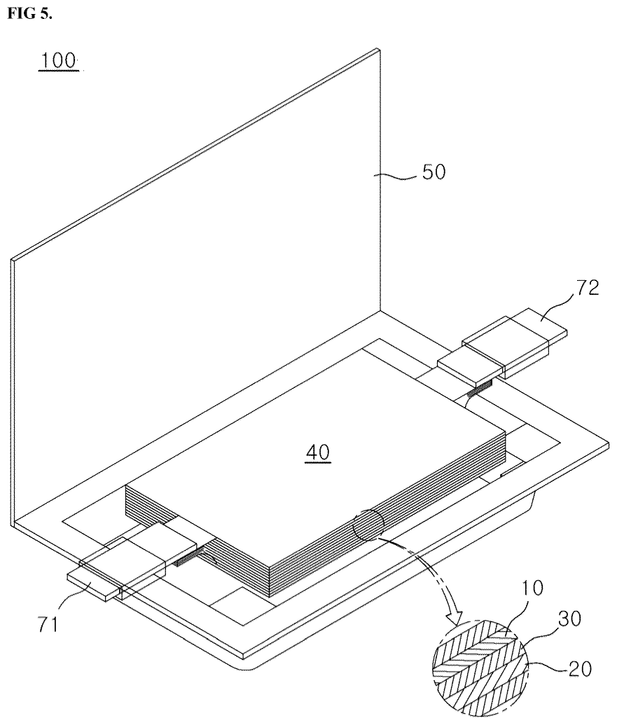

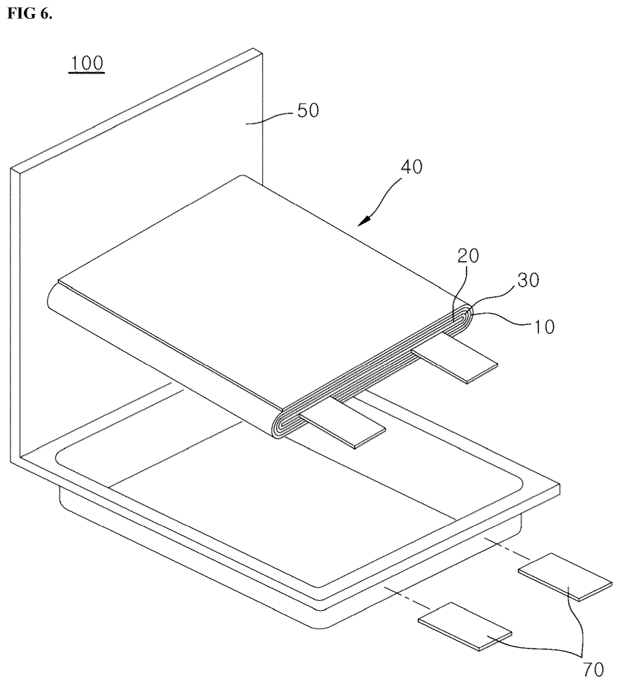

FIG. 3 to FIG. 6 are schematic views illustrating a rechargeable lithium battery according to an example embodiment. FIG. 3 illustrates a cylindrical battery, FIG. 4 illustrates a prismatic battery, and FIG. 5 and FIG. 6 illustrate pouch-type batteries. Referring to FIG. 3 to FIG. 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 3. In FIG. 4, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 5 and FIG. 6, the rechargeable lithium battery 100 may include an electrode tab 70 illustrated in FIG. 6, or, for example, a positive electrode tab 71 and a negative electrode tab 72 illustrated in FIG. 5, the electrode tabs 70/71/72 forming an electric path for inducing the current formed in the electrode assembly 40 to the outside of the battery 100.

The rechargeable lithium battery according to an example embodiment may be applicable to automobiles, mobile phones, and/or various types of electric devices, as non-limiting examples.

Hereinafter, examples and comparative examples of the present disclosure are described. However, the following examples are merely example embodiments of the present disclosure, and the present disclosure is not limited to the following examples.

### Example 1

A pre-dispersion was prepared by dispersing boehmite (particle diameter D100: 0.5 μm, particle diameter D50: 0.2 μm, sheet-shaped) in water. Water was evaporated from the pre-dispersion using a rotary evaporator, and methanol was injected again to prepare a dispersion in which boehmite is dispersed in methanol.

A container holding the dispersion was put in an ice water bath, and under a nitrogen atmosphere, 3-methacryloyloxypropyl trimethoxysilane was added in a dropwise manner and stirred for 30 minutes. At this time, a molar ratio of 3-methacryloyloxypropyl trimethoxysilane and boehmite was 1:1.

The stirred solution obtained above was stirred for 15 hours and refluxed at 65° C., and then the dispersion, which turned cloudy, was put in water to form a precipitate.

The solution including the precipitate was filtered to collect the precipitate, and the precipitate was dried at 30° C. to obtain boehmite surface-modified with 3-methacryloyloxypropyl trimethoxysilane. The surface-modified boehmite has a methacrylate group on an outermost surface thereof. The following Reaction Scheme 1 describes the above process.

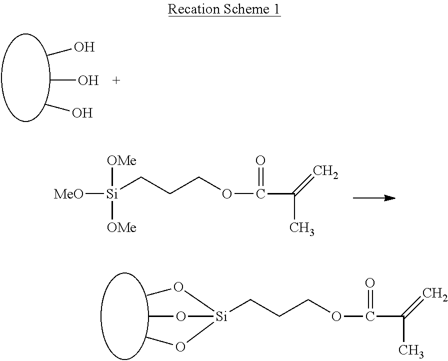

Under a nitrogen atmosphere, the boehmite surface-modified with 3-methacryloyloxypropyl trimethoxysilane and ethylene were mixed at a molar ratio of 1:10, 2-ethoxyethanol was injected as a solvent, azobisisobutyronitrile was added, and the mixture was stirred for 1 hour at normal temperature. Under a nitrogen atmosphere, the mixture was irradiated with UV light for 2 hours at 60° C. to prepare a solution including a copolymer of the boehmite surface-modified with 3-methacryloyloxypropyl trimethoxysilane and ethylene.

The solution was put into a per fluoro alkoxy (PFA) container and then left for 30 minutes at 60° C., 30 minutes at 90° C., and 1 hour at 120° C. to obtain a composition for a coating layer.

The composition for a coating layer was applied at a thickness of 4 μm on one surface of a polyethylene film (thickness: 10 μm, SK, air permeability: 100 sec/100 cc, puncture strength: 480 kgf) as a porous substrate using a die coating method and was dried in an oven for 30 minutes at 70° C. to manufacture a separator for a rechargeable battery.

### Example 2

Unlike in Example 1, the composition for a coating layer was applied at a thickness of 2 μm on both surfaces of a polyethylene film (thickness: 10 μm, SK, air permeability: 100 sec/100 cc, puncture strength: 480 kgf) as a porous substrate using a die coating method and was dried in an oven for 30 minutes at 70° C. to manufacture a separator for a rechargeable battery.

### Example 3

Water and an acidic catalyst were added to 3-methacryloyloxypropyl trimethoxysilane, and a hydrolysis reaction was performed at a predetermined temperature to remove methanol and prepare 3-methacryloyloxypropyl trihydroxysilane.

A surface-modified zirconia particle having a hydroxyl group (Sumitomo Osaka cement) was prepared. The surface-modified zirconia particle having a hydroxyl group was dispersed in water to prepare a dispersion, water was evaporated from the dispersion using a rotary evaporator, and methanol was injected again to prepare a dispersion in which the surface-modified zirconia particle having a hydroxyl group is dispersed in methanol. A container holding the dispersion was put in an ice water bath, and under a nitrogen atmosphere, 3-methacryloyloxypropyl trihydroxysilane was added in a dropwise manner and stirred for 30 minutes. At this time, a molar ratio of 3-methacryloyloxypropyl trihydroxysilane and the surface-modified zirconia particle having a hydroxyl group was 1:1.

The stirred solution obtained above was stirred for 15 hours and refluxed at 65° C., and then the dispersion, which turned cloudy, was put in water to form a precipitate.

The solution including the precipitate was filtered to collect the precipitate, and the precipitate was dried at 30° C. to prepare a zirconia particle surface-modified with 3-methacryloyloxypropyl trihydroxysilane. The surface-modified zirconia has a methacrylate group on an outermost surface thereof.

The zirconia surface-modified with 3-methacryloyloxypropyl trihydroxysilane and methyl methacrylate were mixed at a molar ratio of 1:10, 2-ethoxyethanol was injected, azobisisobutyronitrile was added, and the mixture was stirred for 1 hour at normal temperature. Under a nitrogen atmosphere, the mixture was irradiated with UV light for 2 hours at 60° C. to prepare a solution including a copolymer of the zirconia surface-modified with 3-methacryloyloxypropyl trihydroxysilane and methyl methacrylate.

The solution was put into a PFA container and then left for 30 minutes at 60° C., 30 minutes at 90° C., and 1 hour at 120° C. to obtain a composition for a coating layer. Then, the composition for a coating layer was applied at a thickness of 4 μm on one surface of a polyethylene film (thickness: 10 μm, SK, air permeability: 100 sec/100 cc, puncture strength: 480 kgf) as a porous substrate using a die coating method and was dried in an oven for 30 minutes at 70° C. to manufacture a separator for a rechargeable battery.

### Example 4

Under a nitrogen atmosphere, 3-methacryloxypropyl dimethylchlorosilane (Gelest) was allowed to react with a colloidal silica dispersion (Nissan Chemicals, colloidal silica particles, particle diameter: 20 nm, methylethylketone dispersion) and tetrahydrofurane in a 70° C. oil bath and precipitated in hexane, and a silica particle surface-modified with 3-methacryloxypropyl dimethylchlorosilane was prepared using a centrifuge.

The silica surface-modified with 3-methacryloxypropyl dimethylchlorosilane and methyl methacrylate were mixed at a molar ratio of 1:10, 2-ethoxyethanol was injected, azobisisobutyronitrile was added, and the mixture was stirred for 1 hour at normal temperature. Under a nitrogen atmosphere, the mixture was irradiated with UV light for 2 hours at 60° C. to prepare a solution including a copolymer of the silica surface-modified with 3-methacryloxypropyl dimethylchlorosilane and methyl methacrylate.

The solution was put into a PFA container and then left for 30 minutes at 60° C., 30 minutes at 90° C., and 1 hour at 120° C. to obtain a composition for a coating layer. Then, the composition for a coating layer was applied at a thickness of 4 μm on one surface of a polyethylene film (thickness: 10 μm, SK, air permeability: 100 sec/100 cc, puncture strength: 480 kgf) as a porous substrate using a die coating method and was dried in an oven for 30 minutes at 70° C. to manufacture a separator for a rechargeable battery.

### Example 5

By a method of using a vacuum oven to remove a solvent from a precipitate obtained by stirring an alumina nanoparticle (aluminum oxide, Nanophase Technologies, average particle diameter: 12 nm, specific surface area: 44 m²/g) together with 3-(trimethoxysilyl) propyl methacrylate (Sigma-Aldrich) and tetrahydrofurane for 1 hour at normal temperature, an alumina particle surface-modified with 3-(trimethoxysilyl) propyl methacrylate was prepared.

The alumina surface-modified with 3-(trimethoxysilyl) propyl methacrylate and methyl methacrylate were mixed at a molar ratio of 1:10, 2-ethoxyethanol was injected, azobisisobutyronitrile was added, and the mixture was stirred for 1 hour at normal temperature. Under a nitrogen atmosphere, the mixture was irradiated with UV light for 2 hours at 60° C. to prepare a solution including a copolymer of the alumina surface-modified with 3-(trimethoxysilyl) propyl methacrylate and methyl methacrylate.

The solution was put into a PFA container and then left for 30 minutes at 60° C., 30 minutes at 90° C., and 1 hour at 120° C. to obtain a composition for a coating layer. Then, the composition for a coating layer was applied at a thickness of 4 μm on one surface of a polyethylene film (thickness: 10 μm, SK, air permeability: 100 sec/100 cc, puncture strength: 480 kgf) as a porous substrate using a die coating method and was dried in an oven for 30 minutes at 70° C. to manufacture a separator for a rechargeable battery.

### Example 6

(1)

Both surfaces of a polyethylene film (thickness: 10 μm, SK, air permeability: 100 sec/100 cc, puncture strength: 480 kgf), which was a porous substrate, were treated with oxygen plasma to form a hydroxyl group on a surface of the polyethylene film. The polyethylene film having a hydroxyl group formed thereon was allowed to react with glycidyl methacrylate to prepare a polyethylene film having a methacrylate group on a surface thereof.

(2)

A pre-dispersion was prepared by dispersing boehmite (particle diameter D100: 0.5 μm, particle diameter D50: 0.2 μm, sheet-shaped) in water. Water was evaporated from the pre-dispersion using a rotary evaporator, and methanol was injected again to prepare a dispersion in which boehmite is dispersed in methanol.

A container holding the dispersion was put in an ice water bath, and under a nitrogen atmosphere, 3-methacryloyloxypropyl trimethoxysilane was added in a dropwise manner and stirred for 30 minutes. At this time, a molar ratio of 3-methacryloyloxypropyl trimethoxysilane and boehmite was 1:1.

The stirred solution obtained above was stirred for 15 hours and refluxed at 65° C., and then the dispersion, which turned cloudy, was put in water to form a precipitate.

The solution including the precipitate was filtered to collect the precipitate, and the precipitate was dried at 30° C. to obtain boehmite surface-modified with 3-methacryloyloxypropyl trimethoxysilane.

The boehmite surface-modified with 3-methacryloyloxypropyl trimethoxysilane and ethylene were mixed at a molar ratio of 1:10, 2-ethoxyethanol was injected, azobisisobutyronitrile was added, and the mixture was stirred for 1 hour at normal temperature to prepare a composition for a coating layer.

(3)

The prepared composition for a coating layer was applied at a predetermined thickness on both surfaces of the polyethylene film having a methacrylate group on the surface thereof, and under a nitrogen atmosphere, the composition for a coating layer was irradiated with UV light for 2 hours at 60° C. to manufacture a separator in which the boehmite surface-modified with 3-methacryloyloxypropyl trimethoxysilane and ethylene are polymerized to the polyethylene film.

### Comparative Example 1

Boehmite (particle diameter D100: 0.5 μm, particle diameter D50: 0.2 μm, sheet-shaped) and a water-based acrylic binder were mixed, and the mixture was added to a water solvent, milled for 30 minutes at 25° C. using a bead mill, and dispersed to prepare a composition for forming a coating layer. An acrylic binder and boehmite were included in a mass ratio of 1:30 in the composition for forming a coating layer, and polyvinyl alcohol (PVA) was used as the water-based acrylic binder.

The composition for forming a coating layer was applied at a thickness of 2 μm on both surfaces of a polyethylene film (thickness: 10 μm, SK, air permeability: 100 sec/100 cc, puncture strength: 480 kgf) as a porous substrate using a die coating method and then was dried and aged in an oven for 16 hours at 80° C. to manufacture a separator for a rechargeable lithium battery.

### Comparative Example 2

Boehmite (particle diameter D100: 0.5 μm, particle diameter D50: 0.2 μm, sheet-shaped) and methyl methacrylate were mixed, and azobisisobutyronitrile was added as a photopolymerization initiator to prepare a composition for a coating layer.

The composition for forming a coating layer was applied at a thickness of 2 μm on both surfaces of a polyethylene film (thickness: 10 μm, SK, air permeability: 100 sec/100 cc, puncture strength: 480 kgf) as a porous substrate using a die coating method and then was irradiated with UV light to form a coating layer, thereby manufacturing a separator for a rechargeable lithium battery.

### Air Permeability (Units: Sec/100 cc)

The air permeability was measured by measuring the time (units: seconds) it takes for 100 cc of air to pass through the separator using a measuring device (EG01-55-1MR, Asahi Seiko).

### Air Permeability Measuring Device Setting Conditions:

Measuring pressure: 0.5 kg/cm², cylinder pressure: 2.5 kg/cm², set time: 10 seconds.

### Dry Thermal Shrinkage Rate (Units: %)

The separators for rechargeable lithium batteries of the examples and comparative examples were cut into a size of 10 cm×10 cm to prepare samples. After the samples were allowed to stand in an oven at 150° C. for 1 hour, the dimensions of the sides of the squares of the samples were measured, and the shrinkage rate in each of the machine direction (MD) and transverse direction (TD) was calculated. The shrinkage rate is calculated according to Mathematical Formula 1 below.

$$Shrinkage rate = ( L 0 - L 1 ) / L 0 \times 100 . \qquad Mathematical Formula 1$$

L0 is the initial length of the separator, and L1 is the length of the separator after being allowed to stand at 150° C. for 1 hour.

### Thermal Shrinkage Rate in Electrolyte (Units: %)

The separators for rechargeable lithium batteries of the examples and comparative examples were cut into a size of 8 cm×8 cm to prepare samples. A 5 cm×5 cm square was drawn on the surface of the sample.

As a positive electrode active material, a positive electrode slurry was prepared by mixing 97 wt % LiCoNiAl, 1.5 wt % carbon nanotube as a conductive additive, and 1.5 wt % polyvinylidene fluoride (PVdF) and adding N-methyl-2-pyrrolidone to the mixture. The prepared positive electrode slurry was applied on an aluminum foil, dried, and roll-pressed to manufacture a positive electrode.

As a negative electrode active material, a negative electrode slurry was prepared by mixing 97.4 wt % artificial graphite, 1.0 wt % carboxymethylcellulose, 1.5 wt % styrene-butadiene rubber, and 0.1 wt % carbon nanotube as a conductive additive and adding water to the mixture. The prepared negative electrode slurry was applied on a copper foil, dried, and roll-pressed to manufacture a negative electrode.

One sheet of the sample was placed between the positive electrode and the negative electrode to manufacture three sets of positive electrode-sample-negative electrode laminates, which were then placed in a pouch. 2 g of an electrolyte (1.5 M LiPF₆ dissolved in ethylene carbonate, ethyl methyl carbonate, and dimethyl carbonate (volume ratio of 30:50:20)) was injected to completely saturate the laminate with the electrolyte, and the pouch was sealed and allowed to stand at 25° C. for 12 hours. Then, after being allowed to stand in an oven at 150° C. for 1 hour, the sample was taken out, and then the dimensions of the sides of the drawn square were measured to calculate a shrinkage rate in each of the machine direction (MD) and transverse direction (TD). The shrinkage rate may be calculated according to the above Mathematical Formula 1.

### Battery Resistance (Units: Ω)

The separators were punched using a 18@ punching machine to fabricate CR2032 coin cells. In this process, the punched separator was placed on a bottom cap at the bottom, and about 3 drops of electrolyte (EC/EMC 1.15 M LiPF₆) were added. After placing a gasket, a 1.5 T spacer and a spring were sequentially placed. 10 hours after covering with a top cap and clamping, evaluation was performed using electrochemical impedance spectroscopy (EIS).

### Evaluation of Stability to Heat Exposure

Cells were manufactured using the separators of the examples and comparative examples and by referring to the method described above in the “Thermal shrinkage rate in electrolyte” section. Cells of 4.5 V and 1.5 Ah were put in a chamber, the temperature of the chamber was increased to 170° C. at a temperature increase rate of 3° C./min, and then states of the cells were evaluated.

### Evaluation Criteria:

L0: No response
L1: Reversible damage to performance of battery
L2: Irreversible damage to performance of battery
L3: Decrease in battery electrolyte weight of less than 50%
L4: Decrease in battery electrolyte weight of 50% or more
L5: Ignition or flames (no rupture or explosion)
L6: Rupture of battery (no explosion)
L7: Explosion of battery

TABLE 1

| | | | | Thermal | | | |
|---|---|---|---|---|---|---|---|
| | | Dry thermal | | shrinkage rate | | | |
| | Air | shrinkage rate | | in electrolyte | | Battery | Heat |
| | permeability | MD | TD | MD | TD | resistance | exposure |
| Example 1 | 120 | 1.5 | 1.5 | 2 | 2 | 0.6 | L4 |
| Example 2 | 120 | 1.5 | 1.5 | 2 | 2 | 0.6 | L4 |
| Example 3 | 120 | 1.5 | 1.5 | 2 | 2 | 0.6 | L4 |
| Example 4 | 120 | 1.5 | 1.5 | 2 | 2 | 0.6 | L4 |
| Example 5 | 120 | 1.5 | 1.5 | 2 | 2 | 0.6 | L4 |
| Example 6 | 120 | 1.4 | 1.4 | 1.9 | 1.9 | 0.6 | L4 |
| Comparative | 140 | 2 | 2 | 15 | 15 | 0.65 | L5 |
| Example 1 | | | | | | | |
| Comparative | 135 | 2 | 2 | 10 | 10 | 0.68 | L5 |
| Example 2 | | | | | | | |

As shown in Table 1 above, the separators for rechargeable lithium batteries of the examples exhibited high heat resistance and improved air permeability and had a desired or improved effect of reducing the resistance of a battery and a desired or improved thermal stability.

On the other hand, it was confirmed that the heat resistance was significantly lower in the separators of the comparative examples compared to the examples due to a significantly high dry thermal shrinkage rate and thermal shrinkage rate in an electrolyte.

A separator for a rechargeable battery according to one example embodiment can improve the capacity, lifespan, and safety of a battery by having high heat resistance, exhibiting improved air permeability, and having a desired or improved effect of reducing the resistance of a battery.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A separator for a rechargeable battery, the separator comprising:
a porous substrate; and
a coating layer formed on at least one surface of the porous substrate,
wherein the coating layer comprises a polymer of a mixture including a filler having an unsaturated group.

2. The separator of claim 1, wherein the unsaturated group comprises one or more of a vinyl group and a (meth)acrylate group.

3. The separator of claim 1, wherein the filler comprises one or more of an organic filler and an inorganic filler.

4. The separator of claim 3, wherein the inorganic filler comprises at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

5. The separator of claim 4, wherein the inorganic filler has an average particle diameter D50 in a range of about 10 nm to about 300 nm.

6. The separator of claim 1, wherein the unsaturated group is connected to the filler by a silicon-containing divalent linking group.

7. The separator of claim 1, wherein the filler having the unsaturated group is surface-modified with a silane compound having one or more of a vinyl group and a (meth)acrylate group.

8. The separator of claim 7, wherein the silane compound is represented by Chemical Formula 1: 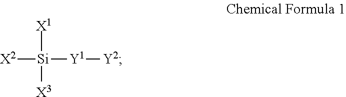
wherein:
X¹, X², and X³ each independently comprises hydrogen, halogen, a hydroxyl group, a substituted or unsubstituted C1 to C20 alkyl group, a substituted or unsubstituted C6 to C20 aryl group, a substituted or unsubstituted C3 to C20 cycloalkyl group, a substituted or unsubstituted C7 to C20 arylalkyl group, a substituted or unsubstituted C1 to C20 alkoxy group, or a substituted or unsubstituted C6 to C20 aryloxy group,
at least any one of X¹, X², and X³ comprises a hydroxyl group, halogen, a substituted or unsubstituted C1 to C20 alkoxy group, or a substituted or unsubstituted C6 to C20 aryloxy group,
Y¹ comprises a divalent C1 to C20 aliphatic hydrocarbon group, a divalent C5 to C20 alicyclic hydrocarbon group, or a divalent C6 to C20 aromatic hydrocarbon group, and
Y² comprises a vinyl group or a (meth)acrylate group.

9. The separator of claim 1, wherein the mixture further comprises a monomer having an unsaturated group.

10. The separator of claim 9, wherein the monomer having the unsaturated group comprises an olefin-based monomer.

11. The separator of claim 10, wherein the olefin-based monomer comprises one or more of ethylene, propylene, butadiene, and a (meth)acrylic acid ester having a C1 to C5 alkyl group in a main chain portion of an ester.

12. The separator of claim 9, wherein, in the mixture, the filler having the unsaturated group and the monomer having the unsaturated group are included in a molar ratio in a range of about 1:6 to about 1:20.

13. The separator of claim 1, wherein the polymer in the coating layer comprises one of a particle type and a film type.

14. The separator of claim 1, wherein at least a portion of the polymer is polymerized to the porous substrate.

15. The separator of claim 14, wherein the porous substrate is modified to have an unsaturated group.

16. The separator of claim 15, wherein the unsaturated group comprises one or more of a vinyl group and a (meth)acrylate group.

17. The separator of claim 14, wherein the porous substrate comprises one or more resins of polyethylene, polypropylene, and polymethyl methacrylate.

18. The separator of claim 1, wherein the polymer is included in an amount of about 95 wt % or more in the coating layer.

19. The separator of claim 1, wherein the coating layer does not include an adhesive binder.

20. A rechargeable battery comprising:
the separator for a rechargeable battery of claim 1;
a positive electrode; and
a negative electrode.
